(19) United States
(12) Patent Application Publication
(10) Pub. No.: US 2011/0031181 A1
(43) Pub. Date: Feb. 10, 2011

(54) FUEL FILTER ASSEMBLY AND METHODS

(76) Inventors: John R. Hacker, Minneapolis, MN (US); Bradley S. Honermann, Prior Lake, MN (US); Mark S. Emery, Minneapolis, MN (US)

Correspondence Address: MERCHANT & GOULD PC, P.O. BOX 2903, MINNEAPOLIS, MN, 55402-0903, US

(21) Appl. No.: 12/864,730

(22) PCT Filed: Jun. 29, 2009
(86) PCT No.: PCT/US09/49077

§ 371 Date: Oct. 28, 2010

Related U.S. Application Data
(60) Provisional application No. 61/076,794, filed on Jun. 30, 2008.

(51) Int. Cl. B01D 27/08; B23K 26/00

(52) U.S. Cl. 210/352; 219/121.64; 210/437; 210/440; 210/438

(57) ABSTRACT

A filter cartridge that includes a housing having first and second housing members, a filter media pack positioned within the housing, and a housing connection defined between the first and second housing members. The first and second housing members each include a flange. The flanges engage each other at an engagement location. The engagement location extends around a circumference of the first housing member along an internal surface of thereof. A permanent housing connection is defined along the engagement location.

This application is being filed on 29 Jun. 2009, as a PCT International Patent application in the name of Donaldson Company, Inc., a U.S. national corporation, applicant for the designation of all countries except the US, and John R. Hacker, Bradley S. Honermann, and Mark S. Emery, all citizens of the U.S., applicants for the designation of the US only, and claims priority to U.S. Provisional patent application Ser. No. 61/076,794, filed Jun. 30, 2008.

### TECHNICAL FIELD

The present disclosure relates generally to fuel filters. More particularly, the present disclosure relates to fuel filters for use with internal combustion engines.

### BACKGROUND

Fuel filter systems to which the invention relates commonly employ a disposable filter cartridge which is replaced at pre-established intervals of filter usage. The replaceable filter cartridge is typically secured to a filter head that forms inlet and outlet connections between the filter cartridge and the fuel supply system. While numerous systems and methods have been employed for assembling a filter cartridge and securing the filter cartridge to the filter head, there is a need for improved systems and methods related to the same.

### SUMMARY

A filter cartridge is provided including a media pack and a housing operably holding the media pack. The housing includes a first housing member having a first surrounding wall defining a first interior volume and having a first flange. The first flange extends around a circumference of the first housing member. The first flange extends radially outwardly from the first surrounding wall. The first flange defines a first end rim defining a uniform circumference. A second housing member has a second surrounding wall defining a second interior volume and having a second flange. The second flange extends around a circumference of the second housing member. The second flange extends radially outwardly from the second surrounding wall. The first surrounding wall circumscribes the second flange. The second flange defines a second end rim defining a uniform circumference. The second flange has an internal surface and an opposite external surface. The internal surface faces the second surrounding wall, and the external surface faces the first surrounding wall. A permanent roll seam-free housing connection is between the first housing member and the second housing member. The connection is at an engagement location between the second flange and the first surrounding wall. The engagement location is circumferential and extending completely along an internal surface of the first surrounding wall and the external surface of the second flange. The connection is sealant-free.

In other aspect, a filter assembly is provided. The filter assembly includes a filter cartridge, as characterized above. A filter head is connected in fluid communication with a source of liquid. A threaded collar is provided. A portion of the first flange of the filter cartridge engages the treaded collar, and the threaded collar is secured to the filter head.

In another aspect, a method of assembling a filter cartridge is provided. The filter cartridge includes first and second housing members, with the first housing member having a first surrounding wall and a first flange extended radially from the first surrounding wall, and the second housing member having a second surrounding wall and a second flange extending radially from the second surrounding wall. Each housing member defines a portion of a housing interior volume sized to receive a filter media pack. The method includes positioning the filter media pack within the housing interior volume. Next, there is a step of engaging an external surface of the second flange against an internal surface of the first surrounding wall to form an engagement location. Next, there is a step of permanently securing the first and second housing members together along the engagement location to form a roll seam-free and a sealant-free permanent connection between the first and second housing members.

Other aspects of the present disclosure relate to methods of assembling a filter cartridge, methods of assembling a filter assembly that includes a filter cartridge and a filter head, and filter cartridge housing assemblies.

Examples of a variety of aspects in addition to those described above are set forth in the description that follows. It is to be understood that both the foregoing general description and the following detailed description are exemplary and explanatory and are not restrictive of the broad inventive aspects which provide a basis for the examples disclosed herein.

### BRIEF DESCRIPTION OF THE DRAWINGS

FIG. 1 schematically shows a perspective view of an example filter cartridge in accordance with the principles of the present disclosure;

FIG. 2 is a top view of the filter cartridge shown in FIG. 1;

FIG. 3 is a cross-sectional view of the filter cartridge shown in FIG. 1;

FIG. 4 is a perspective view of the cross-sectional view of the cartridge only shown in FIG. 3;

FIG. 5 is a close up view of the flange members of the filter cartridge shown in FIG. 3;

FIG. 6 schematically shows a perspective view of another example filter cartridge in accordance with the principles of the present disclosure;

FIG. 7 is a top view of the filter cartridge shown in FIG. 6;

FIG. 8 is a cross-sectional view of the filter cartridge shown in FIG. 7 taken along cross-sectional indicators 8-8;

FIG. 9 is a perspective view of the cross-sectional view shown in FIG. 8;

FIG. 10 is a close up view of the flange members of the filter cartridge shown in FIG. 8;

FIG. 11 is a perspective view of an example filter assembly, including the filter cartridge of FIGS. 1-4, a thread ring, and a filter head;

FIG. 12 is a cross-sectional perspective view of the filter assembly shown in FIG. 11 taken along cross-sectional indicator 12-12;

FIG. 13 is a cross-sectional view of the filter assembly shown in FIG. 11;

FIG. 14 is a close-up view of the thread ring connection to the filter assembly and filter head shown in FIG. 13;

FIG. 15 is a cross-section view of another embodiment of a filter assembly, the view being analogous to the view depicted in FIG. 13, and the embodiment depicting flow in an opposite direction through the filter head as the prior embodiments;

FIG. 16 is a cross-section perspective view of the filter assembly depicted in FIG. 15, the view being analogous to the view depicted in FIG. 12;

FIG. 17 is a cross-sectional view of another embodiment of a filter cartridge constructed in accordance with principles of this disclosure;

FIG. 18 is a cross-sectional view of another embodiment of a filter assembly constructed in accordance with principles of this disclosure; and

FIG. 19 is an enlarged view of a housing connection utilized in the embodiments of FIGS. 17 and 18.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

The present disclosure is directed to various methods, systems and devices related to filter cartridges and filtering systems. One aspect of the present disclosure is directed to structure of a filter cartridge used to mount the filter cartridge to a base such as a filter head. Other aspects of the present disclosure are directed to filter cartridges, in particular the construction of a filter cartridge housing. A filter cartridge housing can include multiple housing pieces that are secured together to define a housing interior sized to receive a filter media pack. One arrangement of a filter cartridge housing includes first and second housing members that each include a flange extending circumferentially around the housing member. Portions of the flange of each housing member engage each other at an engagement location. Typically, the engagement location includes engagement of the flanges around the entire circumference of each of the flanges.

The filter cartridge housing can also include a housing connection that secures the flanges together at the engagement location. Typically, the housing connection is permanent. The term “permanent” used in this context is intended to mean a connection that cannot be broken or fail without significant damage to the pieces that are connected together.

In one example, the housing connection includes a weld seam. In another example, an adhesive or other bonding agent is used at the engagement location to provide the housing connection. Typically, the housing connection is not solely defined by a roll seam or by crimping the flange of one housing member to the flange of the other housing member such as the roll seam connection described in U.S. Pat. No. 6,187,188. Such roll seam connections typically require that the flange of a first housing member wraps around an end surface of the flange of the second housing member. Typically, the housing connections described herein can provide a fluid tight seal.

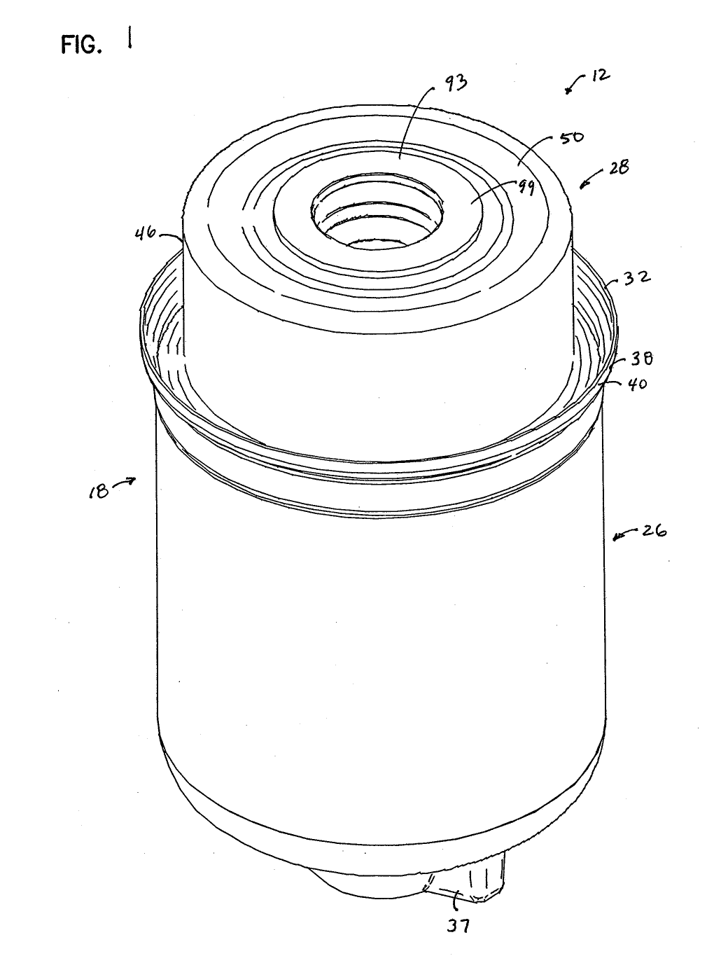

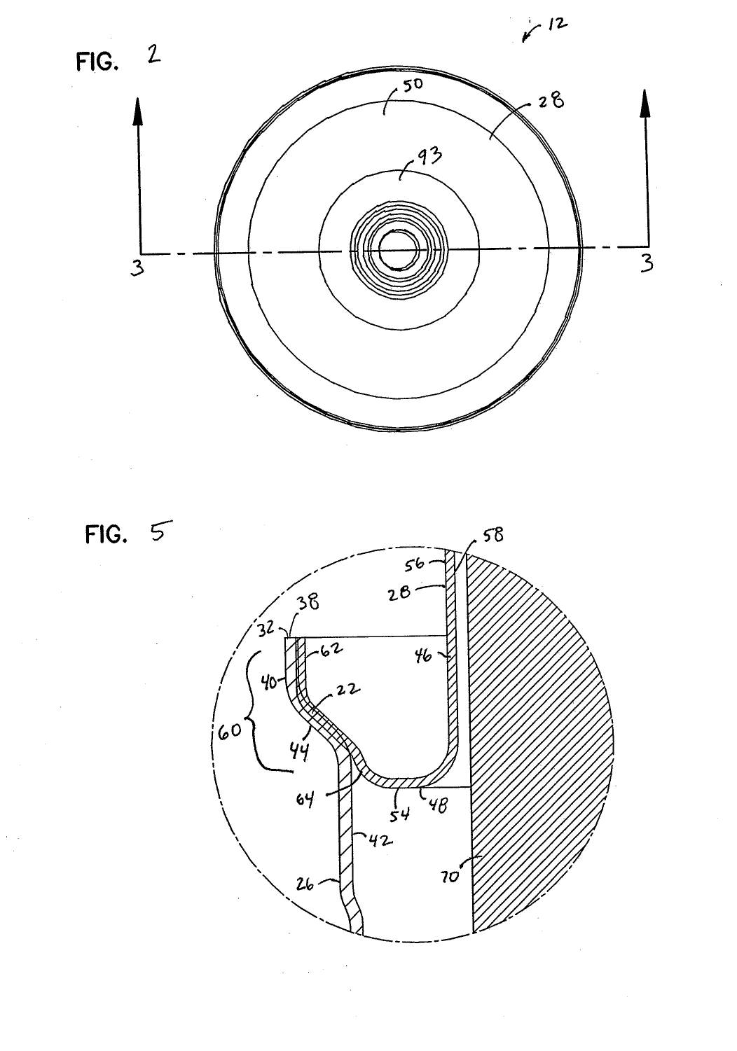

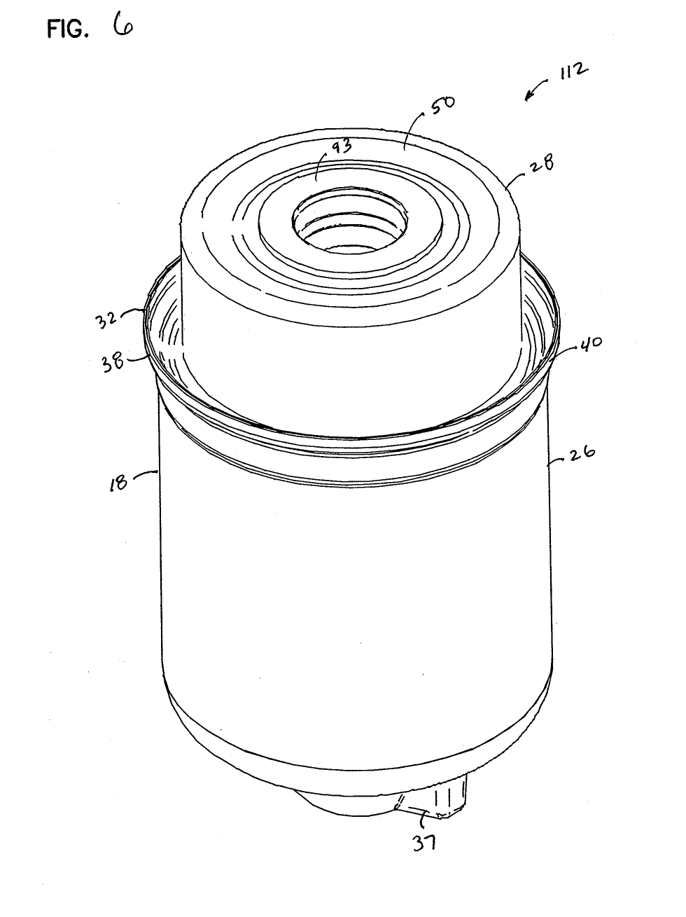

Referring now to FIGS. 1-5, a filter cartridge, generally designated 12, having features that are examples of inventive aspects in accordance with the principles of the present disclosure will be described. While alternatives are possible, the filter cartridge 12 depicted in FIGS. 1-5 includes a housing 18, a filter media pack 20, a housing connection 22 and a spring 24. The housing connection 22 is shown in more detail in the close-up cross-sectional view of FIG. 5.

The housing 18 includes a first housing member 26 and a second housing member 28. The first housing member 26 includes a wall 30 defining a first end 32 and a second end 34. A drain opening 36 is defined in the second end 34. The wall 30 defines an interior volume 45 sized to receive at least a portion of the filter media pack 20.

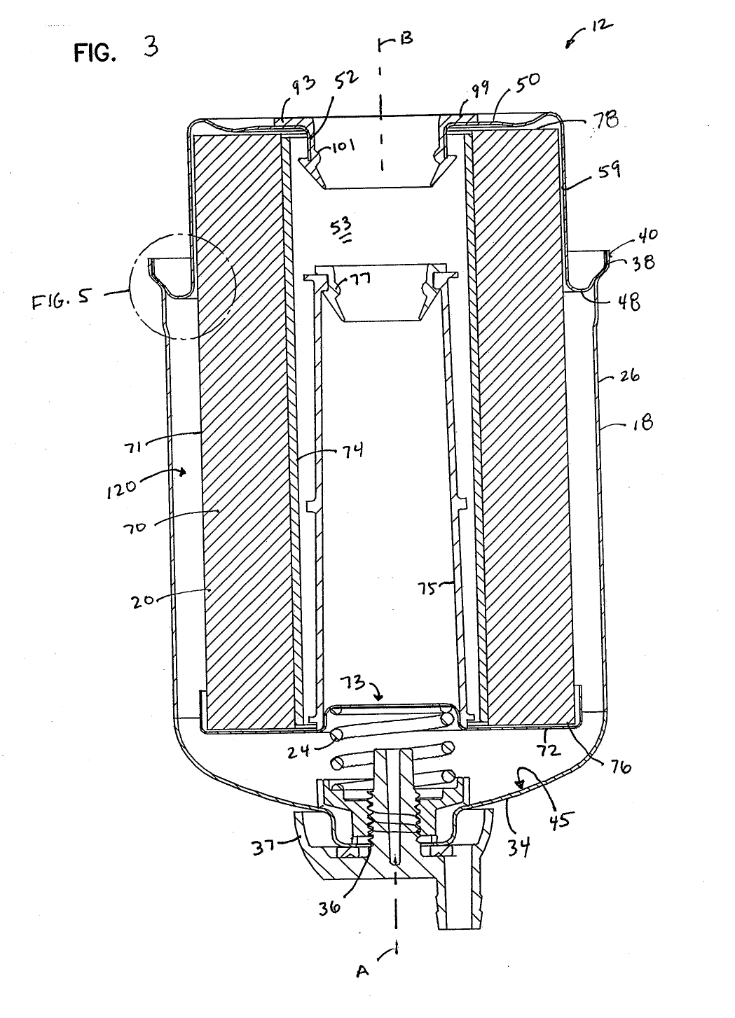

The first housing member 26 also includes a first flange 38 (FIG. 5) that is positioned at the first end 32. In reference to FIG. 5, the first flange 38 has an outer surface 40 and an inner surface 42 that are continuous with outer and inner surfaces of the wall 30. A thread ring engaging surface 44 is defined along the outer surface 40 of the first flange 38. Portions of the first flange 38 extend at least partially radially outward relative to an axis A (FIG. 3) extending centrally through the first housing member 26.

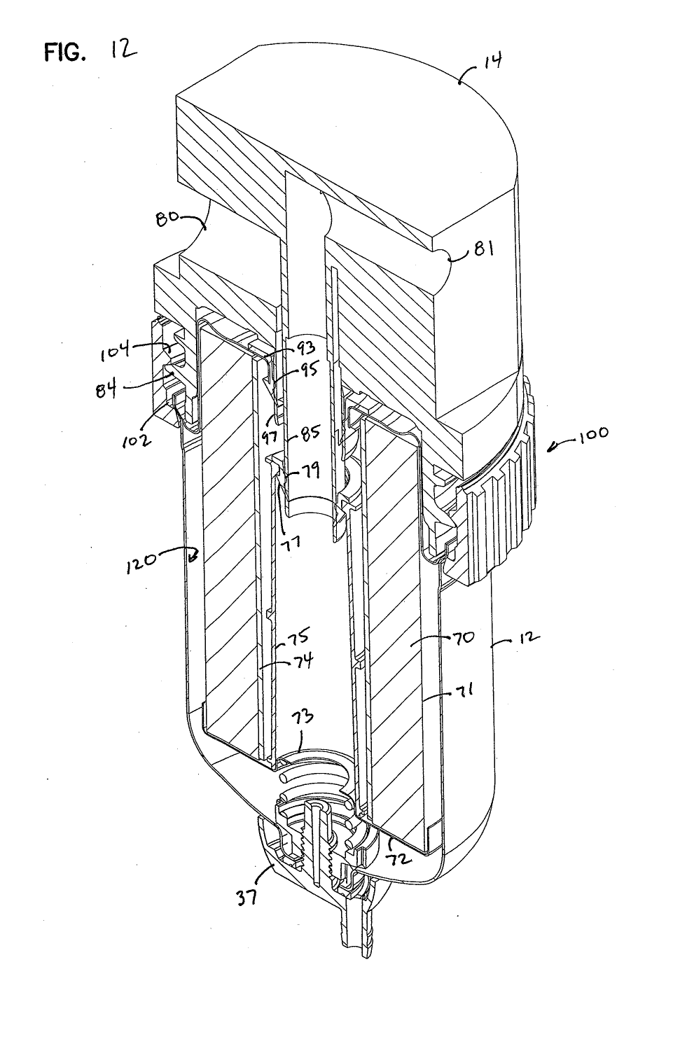

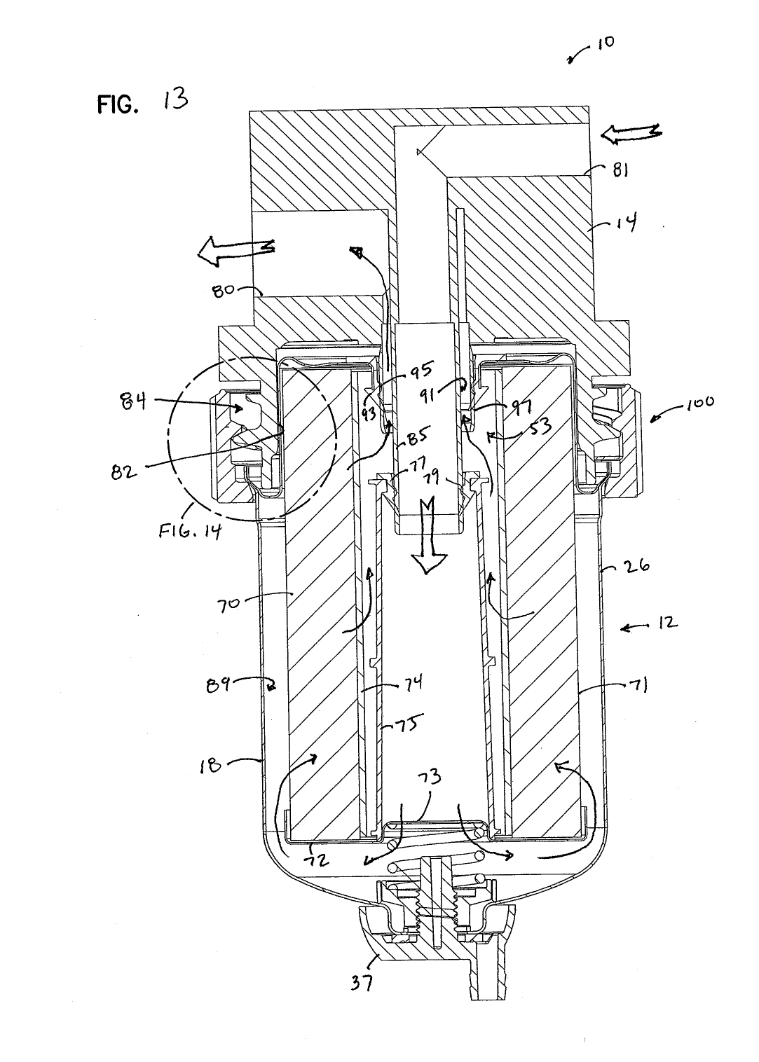

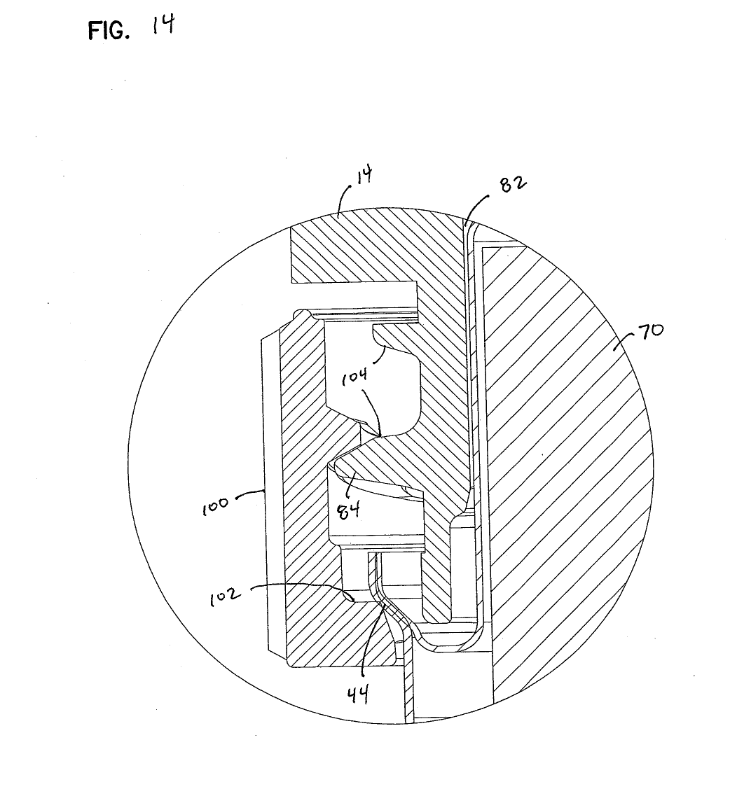

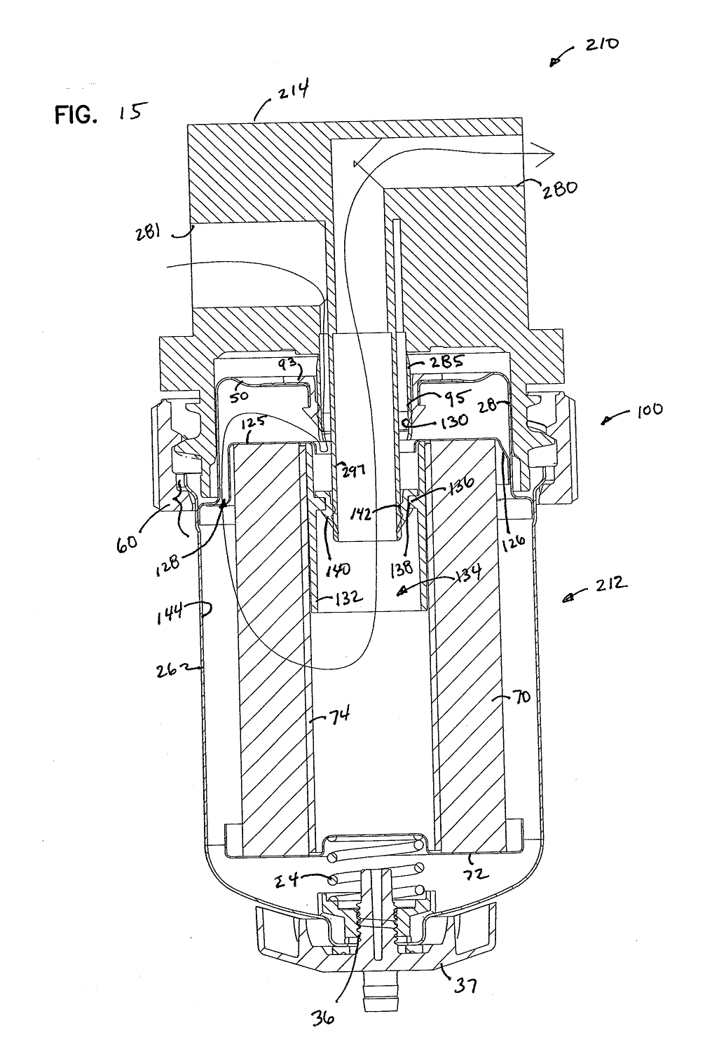

The thread ring engaging surface 44 is configured to engage a thread ring 100 (FIGS. 11-14), which in turn can be used to connect the cartridge 12 to a filter head 14 (FIGS. 11-14). In FIGS. 11-14, the thread ring 100 is shown removably mounted over the cartridge 12. A cartridge engaging lip 102 (FIG. 14) of the thread ring 100 engages the thread ring engaging surface 44 of the flange 38.

In the one shown in FIGS. 11-14, and when set up for forward flow (outside to inside of the filter element), the filter head 14 includes an outlet opening 80, an inlet opening 81, a cylindrical seat 82 (FIG. 13), and thread structure 84. The thread structure 84 operably engages threads 104 of the thread ring 100. Engaging the thread structure 84 with the threads 104, and with the cartridge lip 102 engaging the thread ring engaging surface 44, provides mounting of the filter cartridge 12 to the filter head 14.

The inner surface 42 (FIG. 5) of the first flange 38 (FIG. 5) is configured for engagement by a flange of the second housing member 28, as will be described in further detail below. The outer surface 40 of the first flange 38 is typically continuous and uninterrupted. A maximum outer dimension of the first housing member 26 (e.g., a maximum diameter measured at the outer surface 40 at each position along the axis A) is typically constant at any given axially position. That is, the flange 38 usually does not include protrusions, gaps, cam surfaces or other discontinuous structures defined in the outer surface 40 around the circumference of the first flange 38. The outer surface of the wall 30 also includes a constant maximum outer dimension in that portion of the wall 30 between the first flange 38 and the second end 34. This generally smooth, continuous outer surface of the wall 30 and flange 38 can help reduce internal stresses that exist within the first housing member 26. Typically, the housing 18 is constructed to operate with internal pressures above atmospheric pressure. In some arrangements, the housing 18 can be considered a pressure vessel.

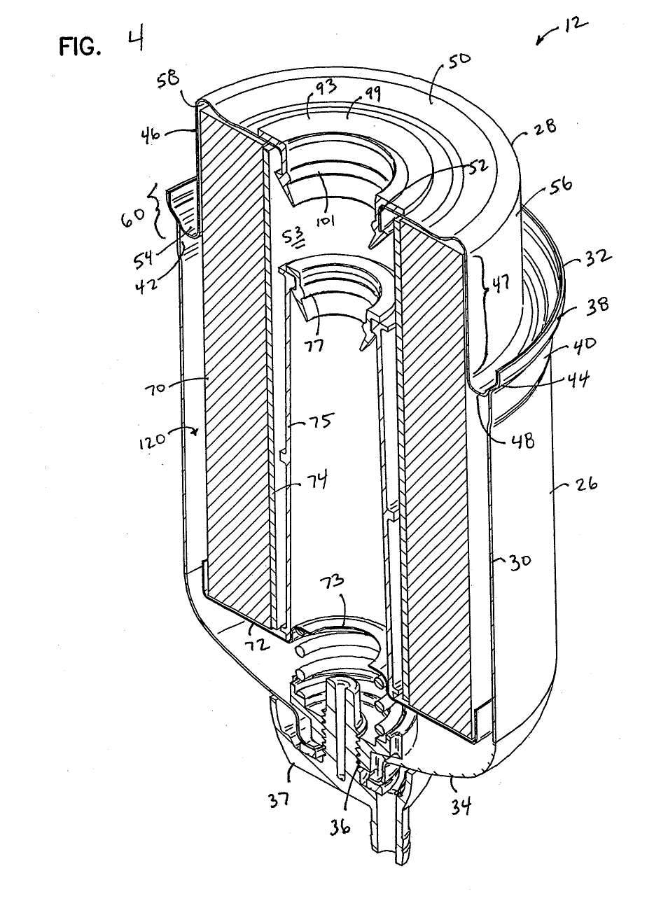

The second housing member 28 includes a wall 46 that defines a first end 48 and a second end 50. In the embodiment shown, the second end 50 defines an aperture 52. The aperture 52 is in communication with an open filter interior 53 of the cartridge 12. A second flange 54 (FIG. 5) is defined by the first end 48. In FIG. 5, it can be seen that the wall 46 includes an outer surface 56 and an inner surface 58. The second flange 54 defines an inner surface 62 and an outer surface 64. In the arrangement shown in FIGS. 1-5 and referring in particular to FIG. 5, the second flange 54 is the same part as the wall 46 in that the outer surface 56 of the wall 46 is continuous with the inner surface 62 of the second flange 54, and the inner surface 58 of the wall 46 is continuous with the outer surface 64 of the second flange 54. That is, by reviewing FIG. 5, it can be seen that in this embodiment, the second flange 54 includes portions that are inverted relative to the generally cylindrical portion 47 (FIG. 4) of the wall 46.

The second housing member 28 defines an interior volume 59 sized to operably receive at least a portion of the filter media pack 20. The interior volume 45 (FIG. 3) of the first housing member 26 and the interior volume 59 (FIG. 3) of the second housing member 28 define an enclosed space sized to receive filter media pack 20. When the embodiment includes a spring, the spring 24 can be positioned between the filter media pack 20 and the second end 34 (FIG. 3) of the first housing member 26 to bias the filter media pack 20 against the second end 50 of the second housing member 28.

The second flange 54 includes at least a portion thereof that extends radially outward relative to a central axis B (FIG. 3) extending through the second housing member 28. Typically, the axis B is arranged coaxial with the central axis A (FIG. 3) of the first housing member 26. A portion of the second flange 54 is arranged to permanently engage and connect to a portion of the first flange 38 at an engagement location 60 (see FIG. 5). The engagement location 60 typically extends around an entire circumference of the first and second flanges 38, 54. The engagement location 60 of cartridge 12 extends around an entire circumference of the inner surface 42 of the first flange 38 of the first housing member 26 and an entire circumference of the outer surface 64 of the second flange 54 of the second housing member 28.

The engagement location 60 can be defined at various positions along the inner surface 42 of the first flange 38 and the outer surface 64 of the second flange 54. FIG. 5 illustrates engagement between the first and second flanges 38, 54 along the inner surface 42 at a location opposite the thread ring engaging surface 44. The housing connection 22 can be formed at any of the engagement locations 60 existing between the first and second flanges 38, 54. The housing connection 22 is typically constructed as a permanent and fluid-tight seal between the first and second flanges 38, 54 at the engagement location 60.

The housing connection 22 can be formed using a variety of structures or methods. For example, the housing connection 22 can be defined by a weld, such as a welded seam. A weld can be formed using, for example, laser welding or arc welding. Another type of housing connection can be defined using an adhesive that creates a bond between the first and second flanges 38, 54. Other types of connecting methods and structures are possible for the housing connection 22. The housing connection 22 is typically permanent once formed. In some arrangements, the housing connection 22 becomes permanent after a delay period such as the time required for the material defining the housing connection 22 to cure or cool.

It is possible to have an engagement location 60 defined between one of the first and second flanges 38, 54 and the wall of the opposing housing member at a location that does not include a portion of the flange of that housing member. For example, the second flange 54 can be constructed to engage the first housing member at a location space between the first flange 38 and the second end 34.

The outer surface 64 of the second flange 54 is generally continuous and does not include projections, cam surfaces or discontinuities around the circumference of the second flange 64 at any given axially location along the axis B. Likewise, the outer surface 56 of the wall 46 of the second housing member 28 is generally continuous and free of projections or discontinuities around the circumference thereof at any axially location along the axis B at a location spaced between the second flange 54 and the second end 50. As described above with reference to first housing member 26, removing such projections, discontinuities, or other structures from the second housing member 28 along the outer surfaces 56, 64 thereof, can reduce internal stress that might otherwise be present.

The filter cartridge 12 is constructed with drain opening 36 at the second end 34 of the first housing member 26 and an inlet/outlet opening 52 at the second end second housing member 28. The drain opening 36 can be selectively opened for draining by rotating knob 37. For example, the drain opening 36 can be part of a drain valve assembly constructed in accordance with the drain valve described in U.S. Pat. No. 6,012,485, incorporated herein by reference.

Attention is directed to FIG. 13 showing the filter assembly 10. The assembly 10 includes the cartridge 12 connected to the filter head 14. The opening 52 in the cartridge 12 can be coupled to the filter head 14 to be in fluid communication with output flow of fluid from the filter cartridge 12 via the outlet channel 80 in the filter head 14. The opening 52 in the cartridge 12 can also be coupled in fluid communication with an input flow of fluid to the filter cartridge 12 via the inlet opening 81, also referred to herein as inlet channel 81. A seal member 93 is mounted within the opening 52 to form a seal 95 (FIG. 13) with an outlet channel tube 97 on the filter head 14. The seal member 93 has an axial component 99 on an axial portion of the second end 50 of the second housing member 28 and an annular component 101 lining the circumference of the opening 52.

The filter media pack 20 can include a filter media 70 (such as pleated media, for example, pleated cellulose) formed in a tubular form or cylinder defining open filter interior 53. An end cap 72 is secured to a first end 76 of the media 70 at a location nearer to the drain opening 36 than the opposite second end 78, which is nearer to the filter head 14. An inner liner 74 helps to support the filter media 70 and is circumscribed by the media 70. The inner liner 74 is porous, to allow the flow of fluid therethrough. In addition, in the embodiment shown, there is further included an internal non-porous pipe 75. The pipe 75 extends from the end cap 72 at least a partial length of the media 70. In the embodiment shown, the pipe 75 extends at least 50% and typically 60-80% of the length of the media 70. The pipe 75 is spaced from the second end 50, in the embodiment shown. The pipe 75 holds a seal member 77 to form a seal 79 (FIG. 13) with an inlet channel tube 85, which is part of the filter head 14. The inlet channel tube 85 is circumscribed by outlet channel tube 97, which is radially spaced from the inlet channel tube 85 to define an outlet channel volume 91 therebetween. In FIG. 13, it can also be seen that the inlet channel tube 85 is longer than the outlet channel tube 97.

The end cap 72 can include an opening arrangement 73 (FIG. 4), embodied herein as a single hole, that permits fluid flow as shown in FIG. 13. In FIG. 13, it can be seen that in the forward flow arrangement depicted, fluid to be filtered enters the filter head 14 through the inlet channel 81, flows through the inlet channel tube 85, and then enters an internal volume defined by the pipe 75. From there, the fluid flows through the opening arrangement 73, into volume 89 (volume 89 being the volume defined between the housing wall 26 and an outer portion of the media pack 70), and then flows through the filter media 70. From there, it enters the open filter interior 53. It then flows through volume 91, which is the volume between the outer surface of the inlet channel tube 85 and the filter head 14. It then flows into the outlet channel 80 of the filter head 14.

The internal dimensions of the first and second housing members 26, 28 can be sized to help provide a gap between the exterior surface 71 of the filter media 70 and at least a portion of the internal surface of the housing 18 to create a fluid flow path 120 therebetween. FIG. 3 illustrates an internal dimension of the second housing member 28 that is sized substantially the same as the external dimension of the filter material 70. An internal dimension of the first housing member 26 is greater than the external dimension of the filter media 70. With this construction, the second housing member 28 can help retain the filter media pack 20 aligned with the axis A, B while the first housing member 26 is sized to provide a desired flow path for fluid flow.

Referring now to FIGS. 6-9, another example filter cartridge, generally designated 112, having features that are examples of inventive aspects in accordance with the principles in the present disclosure will now be described.

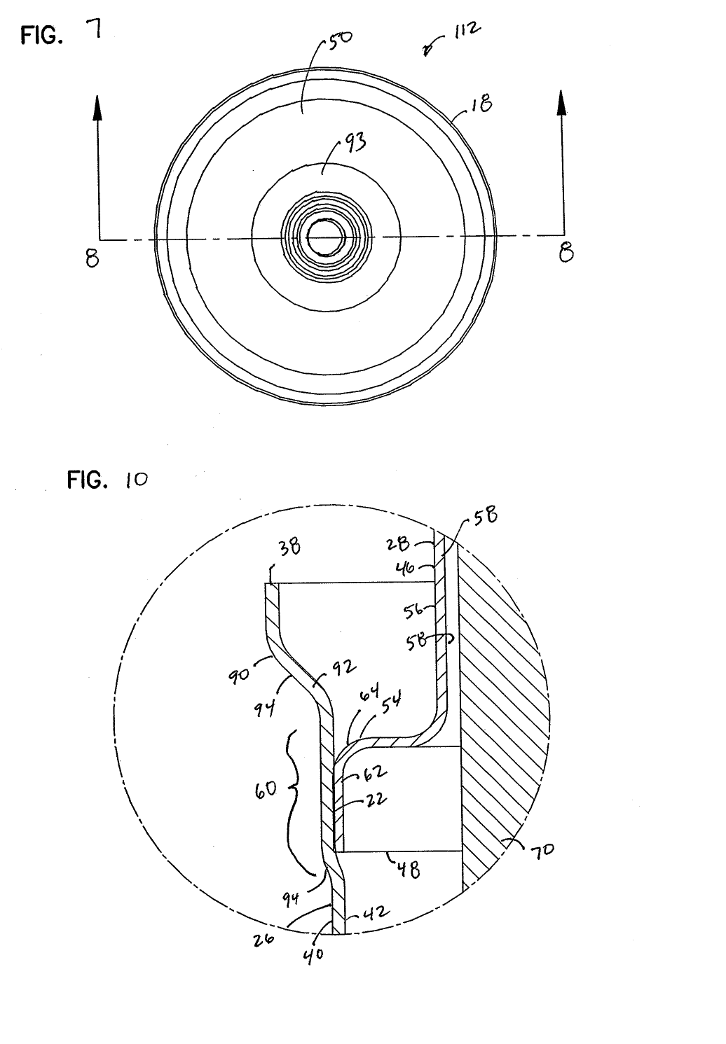

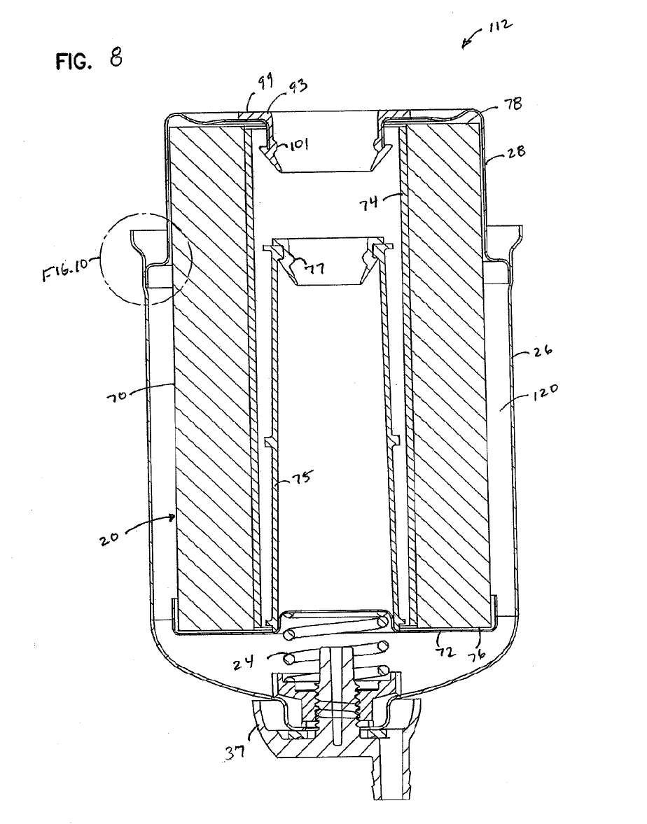

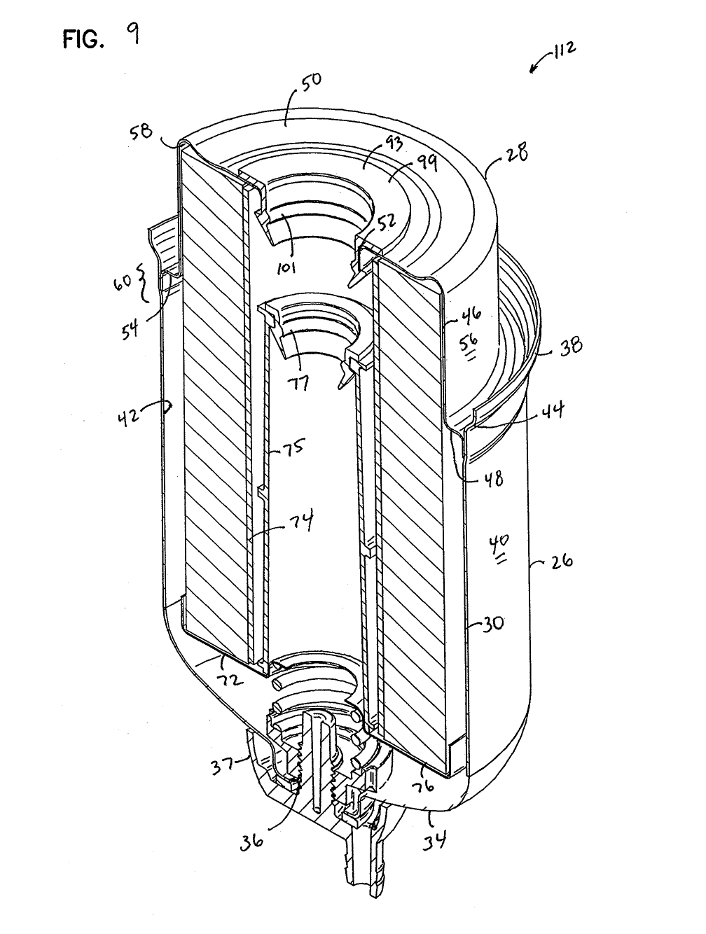

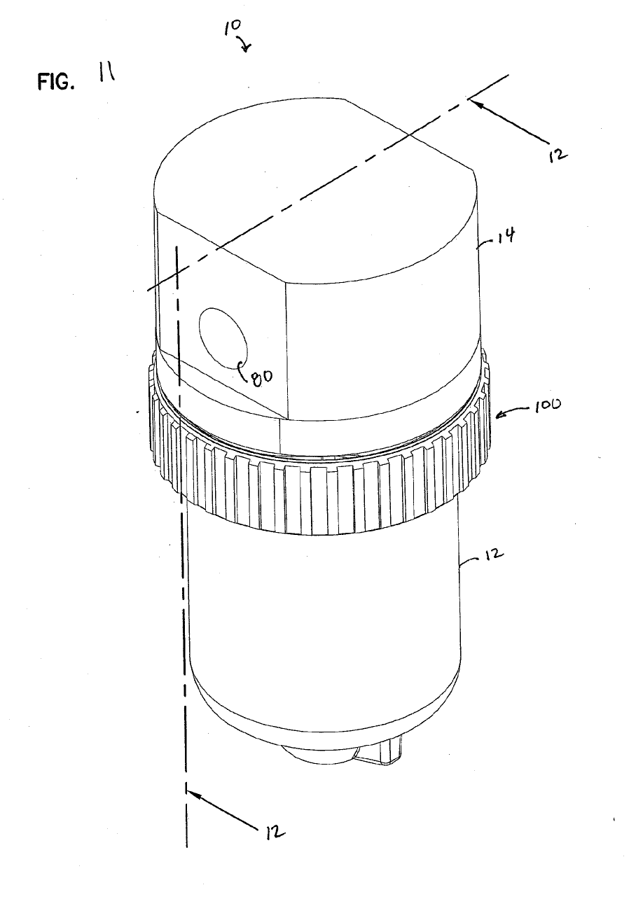

The filter cartridge 112 includes many of the same or similar features as those described above relative to filter cartridge 12. The filter cartridge 112 includes a first housing member 26 having a first flange 38 and a second flange 54. The second flange 54 has a different construction than the second flange 54 described above relative to filter cartridge 12. The second flange 54 is not inverted (as opposed to the embodiment depicted in FIG. 5, where the second flange 54 is inverted). In FIG. 10, that the outer surface 56 of the wall 46 is continuous with the outer surface 64 of the flange 54, and the inner surface 58 of the wall 46 is continuous with the inner surface 62 of the flange 54.

Engagement location 60 is defined between the first and second flanges 38, 54 and is positioned at a location between the thread ring engaging surface 44 and the second end 34. The outer surface 64 of the flange 54 engages the inner surface 42 of the first flange 38 at the engagement location 60. In the embodiment shown, a housing connection 22 is defined at the engagement location 60. The engagement location 60 and housing connection 22 can have the same or similar features and functionality as described above with reference to filter cartridge 12.

In the embodiment depicted in FIG. 10, the first flange 38 includes a plurality of bends 90, 92, 94 along the length thereof. A portion of the flange 38 is defined between each of the bends 90, 92, 94 (see FIG. 10). A section of the first flange 38 defined between a given pair of bends can have a maximum internal dimension. Typically, the smallest maximum internal dimension of any given section of the first flange 38 is greater than the maximum internal dimension of the remaining portion of the wall 30 that extends from the first flange 38 to the second end 34 of the first housing member 26. The bend 94 shown in FIG. 10 can act as a position stop against which the second flange 54 engages to limit further axial advancement of the second housing member 28 into the first housing member 26 along the axis' A, B. Such a position stop can be defined without the addition of discontinuities, projections or other structures provided in addition to the flanges 38, 54 that might add undesirable internal stress to the first housing member 26.

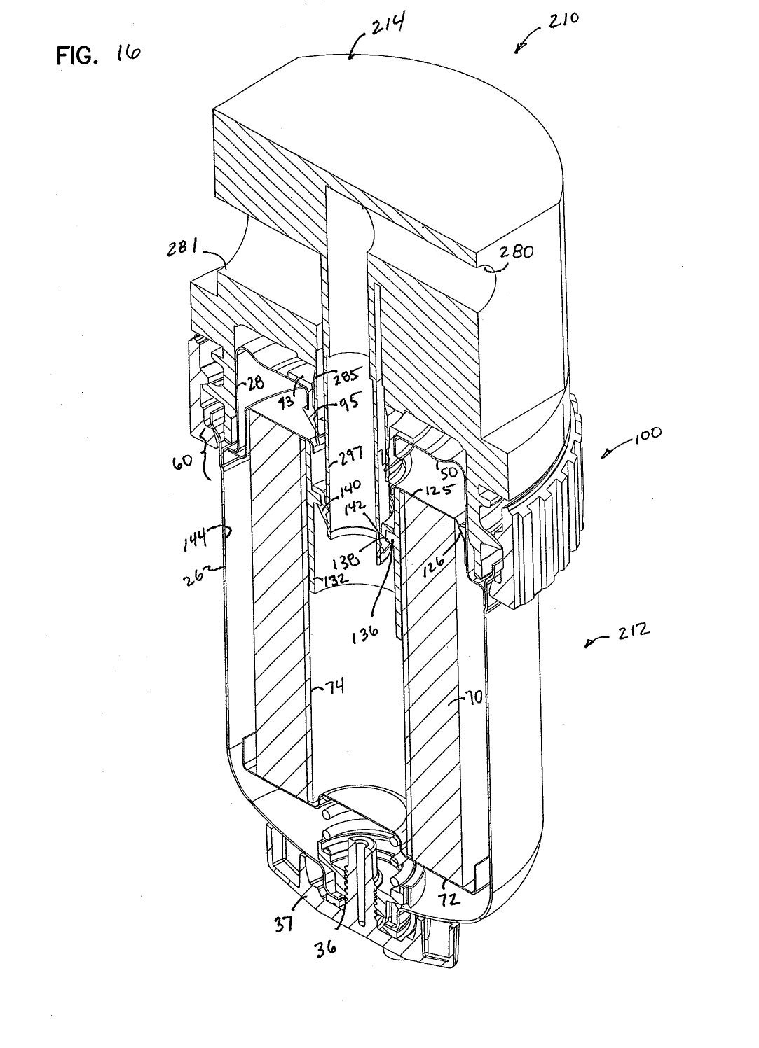

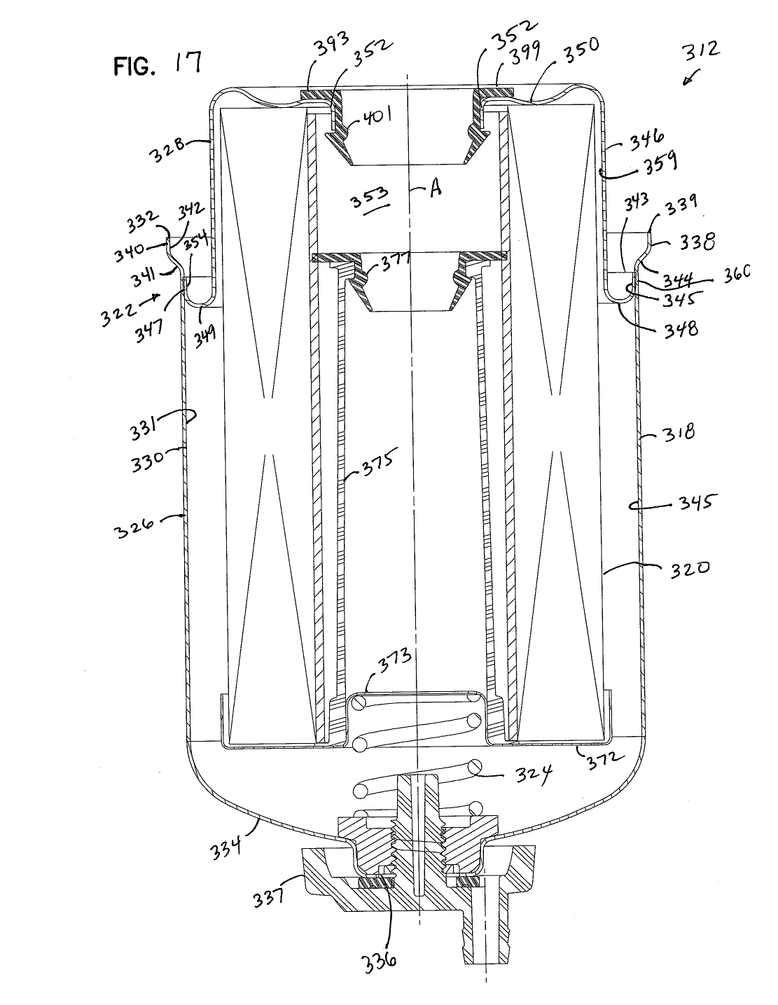

Attention is next directed to the embodiment of FIGS. 15 and 16. In this embodiment, the assembly 210 includes a filter head 214 in which the fluid flow is opposite than the fluid flow direction shown in previous embodiments. Because of this reverse direction of flow, the cartridge 212 is configured differently. The engagement location 60 is generally the same as shown in FIG. 10.

Still in reference to FIGS. 15 and 16, the filter head 214 has an inlet channel 281 and an outlet channel 280. Fluid to be filtered flows into the filter head 214 through the inlet channel 281, then flows in volume 130 between inlet channel tube 285 and an outer wall of outlet channel tube 297, into the cartridge 212 where contaminants are filtered from the fluid, fluid exits the cartridge 212, flows back into the filter head 214 through outlet channel tube 297, and then exits the filter head 214 through the outlet channel 280.

In the embodiment shown in FIGS. 15 and 16, the cartridge 212 includes first housing member 26, second housing member 28, and filter media 70. An inner liner 74 supports the media 70. In this embodiment, the filter media 70 is axially spaced from the second end 50 of the second housing member 28. The cartridge 212 also includes an end cap 125 at the end of the media 70 nearest to the filter head 214. The end cap 125 is secured to the media 70 and includes a plurality of circumferentially spaced ribs 126. The ribs 126 engage an inner surface of the second housing member 28 and help to center and space the media 70 from the second housing member 28. In between the ribs 28 are flow spaces 128 to allow the flow of unfiltered fluid from the inlet opening 281 of the filter head 214 before it flows through the media 70.

In the embodiment of FIGS. 15 and 16, the cartridge 212 further includes a non-porous inner pipe 132. In the one shown in FIGS. 15 and 16, the pipe 132 extends from the upper end cap 125 partially down into the filter interior 134. The pipe 132 is adjacent to, against, and circumscribed by the inner liner 74. In many embodiments, the pipe 132 extends at least 33% of the length of the media 70. The pipe 132 includes an inner radial ring 136, which is a complete ring extending radially inwardly. The ring 136 defines an outlet channel tube opening 138, which is sized to receive the outlet channel tube 138 of the filter head 214. A seal member 140 is held by the ring 136 and forms a seal 142 between the ring 136 of the pipe 132 and the outlet channel tube 138.

In operation, in the embodiment of FIGS. 15 and 16, fluid to be filtered flows through inlet channel 281 in the filter head 214, through the volume 130 defined by inlet channel tube 285, into volume 144, through the media 70, into open filter interior 134, through the outlet channel tube 297, and then out through the outlet channel 280. The seal 142 prevents unfiltered fluid from bypassing the media 70 and flowing into open filter interior 134. The seal 95 prevents fluid from escaping the cartridge 212.

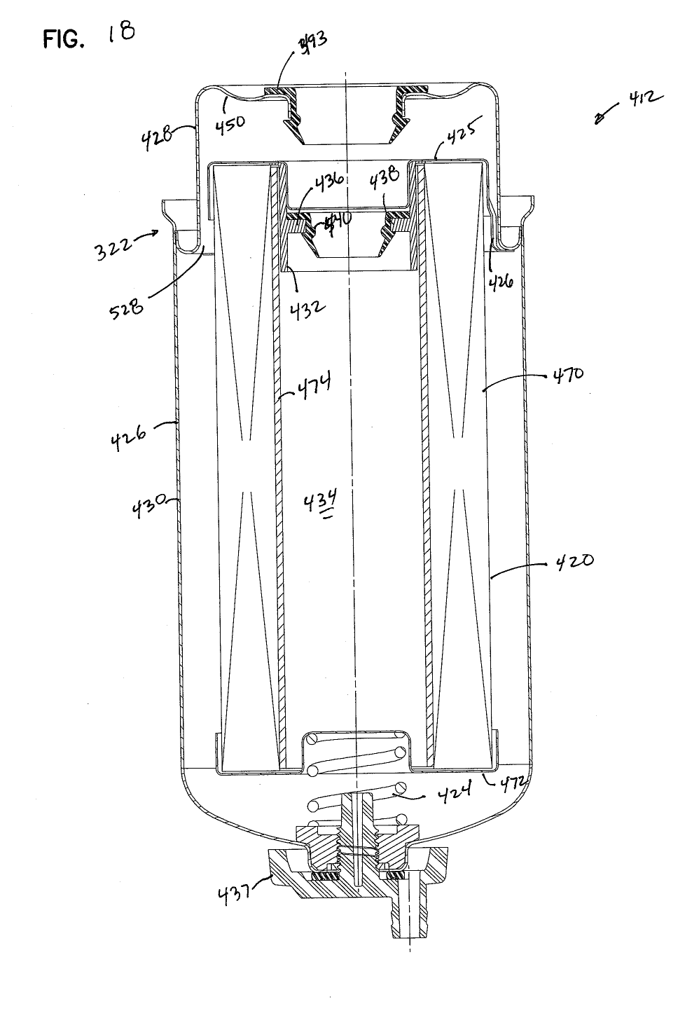

In reference now to the embodiments of FIG. 17, a filter cartridge is shown at 312 and has many features analogous to the filter cartridge 12 at FIGS. 1-5. One difference between the filter cartridge 12 of FIGS. 1-5 and the filter cartridge 312 of FIG. 17 is the housing connection between the first and second housing members, which are shown in FIG. 19 and which will be described further below.

In the embodiment of FIG. 17, the filter cartridge 312 includes a housing 318, filter media 320, a housing connection 322, and a spring 324. The housing connection 322 is shown in more detail in the enlarged cross-sectional view of FIG. 19.

The housing 318 includes a first housing member 326 and a second housing member 328. The first housing member 326 includes a first surrounding wall 330 having a first end 332 and a second end 334. The surrounding wall 330 defines an interior volume 345 sized to receive at least a portion of the filter media pack 320.

The first housing member 326 includes a first flange 338 that is positioned to define the first end 332. The first flange 338 has an outer surface 340 and an inner surface 342. The outer surface 340 is continuous with the outer surface of the wall 330. The inner surface 342 is continuous with the inner surface of the wall 330. A thread ring engaging surface 344 is defined along the outer surface 340 of the first flange 338. Portions of the first flange 338 extend at least partially radially outwardly relative to the central longitudinal axis A, which extends centrally through the first housing member 326.

The thread ring engaging surface 344 is configured to engage a thread ring, such as thread ring 100 illustrated in FIGS. 11-14. This can then be used to connect the cartridge 312 to a filter head, such as the filter head 314 shown in FIGS. 11-14.

The filter cartridge 312 can be assembled and connected to a filter head in the same way as shown and described with respect to cartridge 12, filter head 14, and thread ring 100 in connection with FIGS. 11-14.

The first flange 338 has a first end rim 339. The first end rim 339 also defines the first end 332 of the wall 330. In preferred implementations, the first end rim 339 defines a uniform circumference. By the term “uniform circumference”, it is meant generally circular without protrusions or gross deviations. The uniform circumference of the rim 339 is generally the same as the circumference of the first flange 338, and it is typically continuous and uninterrupted. A maximum outer dimension of the first housing member 326 is typically constant at any given axial position as measured from the axis A. That is, the flange 338 does not include protrusions, gaps, cam surfaces, or other discontinuous structures defined in the outer surface 340 around the circumference of the first flange 338.

The second housing member 328 includes a wall 346 that defines a first end 348 and a second end 350. In the embodiment shown, the second end 350 defines an aperture 352. The aperture 352 is in communication with an open filter interior 353 of the filter cartridge 312. A second flange 354 is defined by the first end 348. The second surrounding wall 346 defines a second interior volume 359 sized to operably receive at least a portion of the filter media pack 320. The interior volume 345 of the first housing member 326 and the interior volume 359 of the second housing member 328 define an enclosed space sized to receive the filter media pack 320. The spring 324 can be positioned between the filter media pack 320 and the second end 334 of the first housing member 326 to bias the filter media pack 320 against the second end 350 of the second housing member 328.

Still in reference to FIG. 17, the second flange 354 extends around a circumference of the second housing member 328. The second flange 354 extends radially outwardly from the second surrounding wall 346. In the embodiments shown, the first surrounding wall 330 circumscribes the second flange 354.

In the embodiment shown, the second flange 354 defines a second end rim 343. The second end rim 343 defines a uniform circumference, which generally is circular and does not have any gross deviations therefrom.

In the embodiments shown, the second flange 354 has an internal surface 345 and an opposite external surface 347. In the embodiment shown, the internal surface 345 faces the second surrounding wall 346, while the external surface 347 faces the first surrounding wall 330. In the embodiments shown, the second housing member 328 includes a U-shaped section 349 between the second surrounding wall 346 and the second flange 354.

As mentioned above, the connection 322 is formed between the first housing member 326 and the second housing member 328. In this embodiment, the housing connection 322 is a permanent connection. By the term “permanent” connection, it is meant that the connection 322 can not be disengaged without breaking or deforming the first housing member 326 and/or the second housing member 328; that is, the connection 322 can be disengaged and then reengaged in an operable manner. In this embodiment, the permanent connection 322 is also roll seam-free. By “roll seam-free” it is meant that the connection 322 is not a roll seam, as that term is commonly understood in the art. The connection 322 is at an engagement location 360 between the second flange 354 and the first surrounding wall 330. The engagement location 360 is circumferential and extending completely along an internal surface 331 of the first surrounding wall 330 and the external surface 347 of the second flange 354.

The connection 322 is permanent, and can be defined by a weld, such as by making the connection 322 be a laser weld seam. Other types of welds can be used. The connection 322 will be sealant-free, which means that sealant is not used in or around the connection 322. The connection 322 can be formed by an adhesive bond.

Still in reference to FIG. 17, in the embodiment shown, the first housing member 326 includes a stepped portion 341 between the first surrounding wall 330 and the first flange 338. The stepped portion 341, in this embodiment, is a radially deflecting portion of the wall 330 that is angled from the straight portion of the wall 330 outwardly to the flange 338. In this embodiment, the second end rim 343 is against the first surrounding wall 330—specifically the inner surface 331 of the wall 330, and does not extend into the stepped portion 341 or the first flange 338.

As with the embodiment of FIGS. 1-5, in this embodiment, the filter cartridge 312 is constructed with a drain opening 336 at the second end 334 of the first housing member 326. The drain opening 336 can be selectively opened for draining by rotating the knob 337. The drain opening 336 can be part of a drain valve assembly constructed in accordance with the drain valve assembly described in U.S. Pat. No. 6,012,485, incorporated herein by reference.

Other components of the filter cartridge 312 are analogous to those described above with respect to FIGS. 1-5. As such, the filter cartridge 312 includes an inlet/outlet opening 352 lined by a seal member 393 having an axial component 399 and an annular component 401. The cartridge 312 further includes an inner tube or non-porous stand pipe 375 extending from a bottom end cap 372. There is an opening arrangement 373, which permits fluid flow as shown in FIG. 13. A seal member 377 is oriented at an end of the stand pipe 375 to form a seal with the filter head, as shown in FIG. 13. In general, with the exception of the details of the connection 322, the other features of the cartridge 312 are the same as described above with respect to the embodiment of cartridge 12 in FIGS. 1-5, and such description is incorporated herein by reference.

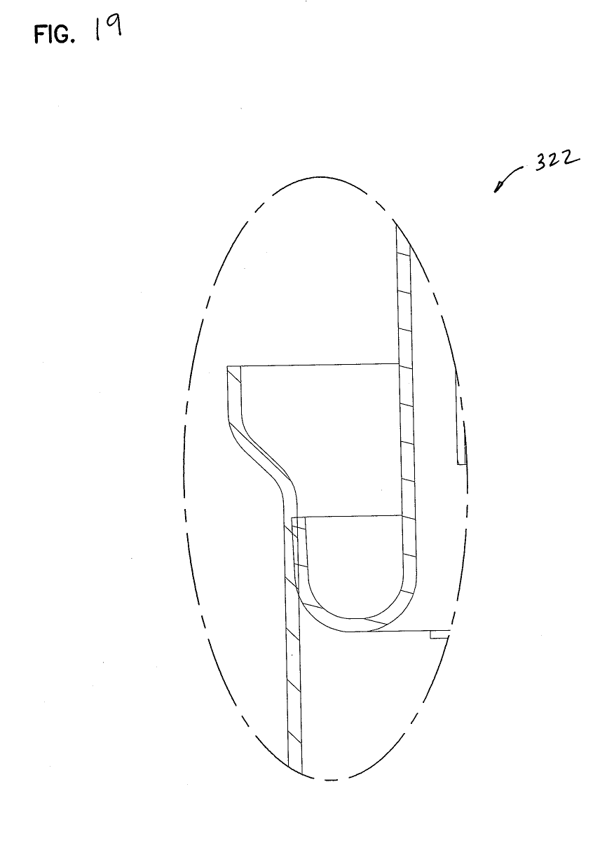

FIG. 18 shows another embodiment of a filter cartridge 412. The filter cartridge 412 is analogous to the embodiment of FIG. 15, and has all of the same features, with the exception of the connection 322. The filter cartridge 412 has the connection 322, which is the same connection 322 as described with respect to FIG. 17 and as shown in FIG. 19. Otherwise, the cartridge 412 has all of the features of the cartridge 212 of FIG. 15, and the description of those features are incorporated herein by reference. In general, the cartridge 412 includes a first housing member 426, a second housing member 428, a filter media pack 420, a spring 424, an end cap 472, a surrounding wall 430, a knob 437, and a seal member 493. An inner liner 474 supports filter media 470. The filter media 470 is axially spaced from the second end 450 of the second housing member 428. The cartridge 412 includes an end cap 425 at the end of the media 470 nearest to the filter head 214 (FIG. 15). The end cap 425 is secured to the media 470 and includes a plurality of circumferentially spaced ribs 426. The ribs 426 engage an inner surface of the second housing member 428 and help to center and space the media 470 from the second housing member 428. In between the ribs 428 are flow spaces 528 to allow the flow of unfiltered fluid from the inlet opening 281 (FIG. 15) of the filter head 214 (FIG. 15) before it flows through the media 470.

The cartridge 412 further includes a non-porous inner pipe 432. The pipe 432 extends from the upper end cap 425 partially down into the filter interior 434. The pipe 432 is adjacent to, against, and circumscribed by the inner liner 474. In this embodiment, the pipe 432 extends at least 10% of the length of the media 470. In many embodiments, the pipe 432 will extend no greater than 15% of the length of the media 470. The pipe 432 includes an inner radial ring 436, which is a complete ring extending radially inwardly. The ring 436 defines an opening 438 which is sized to receive the outlet channel tube 138 (FIG. 15) of the filter head 214 (FIG. 15). A seal member 440 is held by the ring 436 to form a seal between the ring 436 of the pipe 432 and the tube 138 of (FIG. 15).

As mentioned above, the connection 322 is as described with respect to FIG. 17 and shown in FIG. 19.

Various modifications and alterations of this disclosure will become apparent to those skilled in the art without departing from the scope and spirit of this disclosure, and it should be understood that the inventive scope of this disclosure is not to be unduly limited to the illustrative embodiments set forth herein. For example, many other flange structures are possible that define various engagement location configurations that would benefit from the housing connections 22 described above with reference to the illustrated example filter cartridges.

1-16. (canceled)

17. A filter cartridge comprising:
(a) a filter media pack;
(b) a housing operably holding the filter media pack, the housing including:
(i) a first housing member having a first surrounding wall defining a first interior volume, and having a first flange; the first flange extending around a circumference of the first housing member;
(A) the first flange extending radially outward from the first surrounding wall;
(B) the first flange defining a first end rim; the first end rim defining a uniform circumference;
(C) the first housing member including a stepped-portion between the first surrounding wall and the first flange;
(ii) a second housing member having a second surrounding wall defining a second interior volume, and having a second flange, the second flange extending around a circumference of the second housing member,
(A) the second flange extending radially outward from the second surrounding wall;
(B) the first surrounding wall circumscribing the second flange;
(C) the second flange defining a second end rim; the second end rim defining a uniform circumference;
(1) the second end rim being against the first surrounding wall and not extending into the stepped portion or the first flange;
(D) the second flange having an internal surface and an opposite external surface; the internal surface facing the second surrounding wall, and the external surface facing the first surrounding wall;
(E) the second housing member including a U-shaped section between the second surrounding wall and the second flange;
(iii) a permanent roll-seam free housing connection between the first housing member and the second housing member;
(A) the connection being at an engagement location between the second flange and the first surrounding wall;
(B) the engagement location being circumferential and extending completely along an internal surface of the first surrounding wall and the external surface of the second flange; and
(C) the connection being a laser weld seam.

18. A filter cartridge according to claim 17 wherein:
(a) the first flange is constructed and arranged to engage a threaded collar;
the threaded collar attaching the filter cartridge to a filter head.

19. A filter cartridge according to claim 17 wherein:
(a) the first housing member includes a drain opening at a first end;
(b) a valve assembly is operably oriented in the drain opening of the first housing member;
(c) the filter media pack includes a first end extending into the first interior volume; and
(d) a spring member is operably oriented between and against the valve assembly and the first end of the filter media pack.

20. A filter cartridge according to claim 17 wherein:
(a) the filter media pack includes a cylindrical construction of filter media defining an open filter interior and opposing first and second ends;
(i) the first end extending into the first interior volume;
(ii) the second end extending into the second interior volume; and
the cartridge further comprises:
(i) an inner liner extending in the open filter interior between the first and second ends of the media pack; and
(ii) an open aperture in the second housing member engaging the second end of the filter media pack to provide communication with the open filter interior.

21. A filter cartridge according to claim 20 further comprising:
(a) a non-porous pipe extending within the open filter interior, from the first end of the media pack at least partially toward the second end of the media pack.

22. A filter cartridge according to claim 20 further comprising:
(a) an upper end cap positioned at the second end of the media pack;
(b) a non-porous inner pipe extending within the open filter from the upper end cap at least partially down into the filter interior; the pipe being adjacent to, against, and circumscribed by the inner liner.

23. A filter assembly comprising:
(a) a filter cartridge according to claim 17;
(b) a filter head connected in fluid communication with a source of liquid; and
(c) a threaded collar; and wherein a portion of the first flange engages the threaded collar; and the threaded collar is secured to the filter head.

24. A filter cartridge comprising:
(a) a filter media pack;
(b) a housing operably holding the filter media pack, the housing including:
(i) a first housing member having a first surrounding wall defining a first interior volume, and having a first flange; the first flange extending around a circumference of the first housing member;
(A) the first flange extending radially outward from the first surrounding wall;
(B) the first flange defining a first end rim; the first end rim defining a uniform circumference;
(ii) a second housing member having a second surrounding wall defining a second interior volume, and having a second flange, the second flange extending around a circumference of the second housing member;
(A) the second surrounding wall having an inner surface and opposite outer surface;
(B) the second flange extending radially outward from the second surrounding wall;
(C) the first surrounding wall circumscribing the second flange;
(D) the second flange defining a second end rim; the second end rim defining a uniform circumference;
(E) the second flange having an internal surface and an opposite external surface;
(1) the internal surface of the second flange being continuous with the inner surface of second surrounding wall;
(2) the external surface of the second flange being continuous with the outer surface of the second surrounding wall;
(3) the external surface of the second flange facing the first surrounding wall;
(iii) a permanent roll-seam free housing connection between the first housing member and the second housing member;
(A) the connection being at an engagement location between the second flange and the first surrounding wall; and
(B) the engagement location being circumferential and extending completely along an internal surface of the first surrounding wall and the external surface of the second flange.

25. A filter cartridge according to claim 24 wherein:
(a) the first flange is constructed and arranged to engage a threaded collar;
the threaded collar attaching the filter cartridge to a filter head.

26. A filter cartridge according to claim 24 wherein:
(a) the first housing member includes a drain opening at a first end;
(b) a valve assembly is operably oriented in the drain opening of the first housing member;
(c) the filter media pack includes a first end extending into the first interior volume; and
(d) a spring member is operably oriented between and against the valve assembly and the first end of the filter media pack.

27. A filter cartridge according to claim 24 wherein:
(a) the filter media pack includes a cylindrical construction of filter media defining an open filter interior and opposing first and second ends;
(i) the first end extending into the first interior volume;
(ii) the second end extending into the second interior volume; and
the cartridge further comprises:
(i) an inner liner extending in the open filter interior between the first and second ends of the media pack; and
(ii) an open aperture in the second housing member engaging the second end of the filter media pack to provide communication with the open filter interior.

28. A filter cartridge according to claim 27 further comprising:
(a) a non-porous pipe extending within the open filter interior, from the first end of the media pack at least partially toward the second end of the media pack.

29. A filter cartridge according to claim 27 further comprising:
(a) an upper end cap positioned at the second end of the media pack;
(b) a non-porous inner pipe extending within the open filter from the upper end cap at least partially down into the filter interior; the pipe being adjacent to, against, and circumscribed by the inner liner.

30. A filter assembly comprising:
(a) a filter cartridge according to claim 24;
(b) a filter head connected in fluid communication with a source of liquid; and
(c) a threaded collar; and wherein a portion of the first flange engages the threaded collar; and the threaded collar is secured to the filter head.

31. A method of assembling a filter cartridge, the filter cartridge including first and second housing members, the first housing member having a first surrounding wall and a first flange extending radially from the first surrounding wall; the second housing member having a second surrounding wall and a second flange extending radially from the second surrounding wall; each housing member defining a portion of a housing interior volume sized to receive a filter media pack; the method comprising:
(a) positioning the filter media pack within the housing interior volume; the first housing member including a stepped-portion between the first surrounding wall and the first flange; the second housing member including a U-shaped section between the second surrounding wall and the second flange; the second flange defining a second end rim which is against the first surrounding wall and not extending into the stepped portion or the first flange;
(b) engaging an external surface of the second flange against an internal surface of the first surrounding wall to form an engagement location; and
(c) laser welding together the first and second housing members along the engagement location to form a roll-seam free and a sealant-free permanent connection between the first and second housing members.
